(19) United States
(12) Patent Application Publication
(10) Pub. No.: US 2010/0306054 A1
(43) Pub. Date: Dec. 2, 2010

(54) METHOD AND APPARATUS FOR GENERATING ADVERTISEMENTS

(76) Inventors: Robert A. Drake, Nashville, IN (US); Gerald W. Rea, Scottsburg, IN (US); Charles Lehman, Scottsburg, IN (US)

Correspondence Address: BAKER & DANIELS LLP, 300 NORTH MERIDIAN STREET, SUITE 2700, INDIANAPOLIS, IN, 46204, US

(21) Appl. No.: 12/789,138

(22) Filed: May 27, 2010

Related U.S. Application Data
(60) Provisional application No. 61/217,180, filed on May 28, 2009.

(51) Int. Cl. G06Q 30/00; G06F 15/16; G06F 17/27

(52) U.S. Cl. 705/14.53; 705/14.67; 704/9; 709/204

(57) ABSTRACT

A method is provided for automatically generating and delivering customized targeted advertisements from a first computing device to a second computing device used by a user.

### CROSS REFERENCE TO RELATED APPLICATION

This application claims the benefit of U.S. Provisional Application Ser. No. 61/217,180, filed on May 28, 2009, which is expressly incorporated by reference.

### BACKGROUND AND SUMMARY

The present invention relates to systems and methods for automatically generating and delivering targeted advertisements or other electronic messages to a user of a computing device. More particularly, the present invention relates to customizing the language used in the text of the targeted advertisement or other electronic message for particular users.

Many systems and methods are known which provide a group of users the ability to communicate electronically. Examples illustratively include cell phone text messaging, e-mail services, blogs, instant messaging, electronic chat rooms, social network web sites, and other suitable forms of electronic communication.

It is also well known to provide individuals with targeted advertisements. For instance, with its e-mail service Gmail, Google scans an e-mail message that is to be presented to a user. This scan is done for many reasons, such as virus scanning, spam filtering, and the like. Google also scans the text of Gmail messages in order to deliver targeted text advertisements and other related information to the viewer. When a user opens an e-mail message, computers automatically scan the text and then display relevant information that is matched to the text of the message, such as dynamically generated advertisements.

According to one illustrated embodiment of the present disclosure, a method is provided for automatically generating and delivering customized targeted advertisements from a first computing device to a second computing device used by a user. The method includes receiving an electronic communication at the first computing device from the second computing device used by a user, identifying the user with the first computing device, scanning textual content of the electronic communication from the user with the first computing device to determine a subject matter for a targeted advertisement, and retrieving a generic version of textual content of the targeted advertisement with the first computing device. The method also includes accessing a semantic database including a dialect profile linked to the identified with the first computing device to determine a dialect profile for the identified user, performing a dialectification of the generic version of textual content of the targeted advertisement with the first computing device to create a customized targeted advertisement for the identified user, and sending the customized targeted advertisement from the first computing device to the second computing device for display to the identified user.

Additional features of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a block diagram illustrating communication between a plurality of users' computing devices and a computer/server over a communication network;

FIG. 2 is a block diagram illustrating components of a representative computing device;

FIG. 3 is a representative view of various community applications for an exemplary online community;

FIG. 4 is a block diagram illustrating certain functions controlled by an advertisement software application used by the server;

FIG. 5 is a block diagram illustrating various types of electronic communications generated by the users of the plurality of computing devices and the computer/server over the communication network;

FIGS. 6 and 7 are flowcharts illustrating steps performed by the computing devices and the computer/server during operation of the advertisement application of the present disclosure; and

FIG. 8 is another flowchart illustrating additional steps performed by the computing devices and the computer/server during operation of the advertisement application of the present disclosure.

### DETAILED DESCRIPTION OF THE DRAWINGS

For the purposes of promoting an understanding of the principles of the invention, reference will now be made to certain illustrated embodiments and specific language will be used to describe the same. No limitation of the scope of the claims is thereby intended. Such alterations and further modifications of the invention, and such further applications of the principles of the invention as described and claimed herein as would normally occur to one skilled in the art to which the invention pertains, are contemplated, and desired to be protected. The embodiments of the invention described herein are not intended to be exhaustive or to limit the invention to the precise forms disclosed. Rather, the embodiments selected for description have been chosen to enable one skilled in the art to practice the invention.

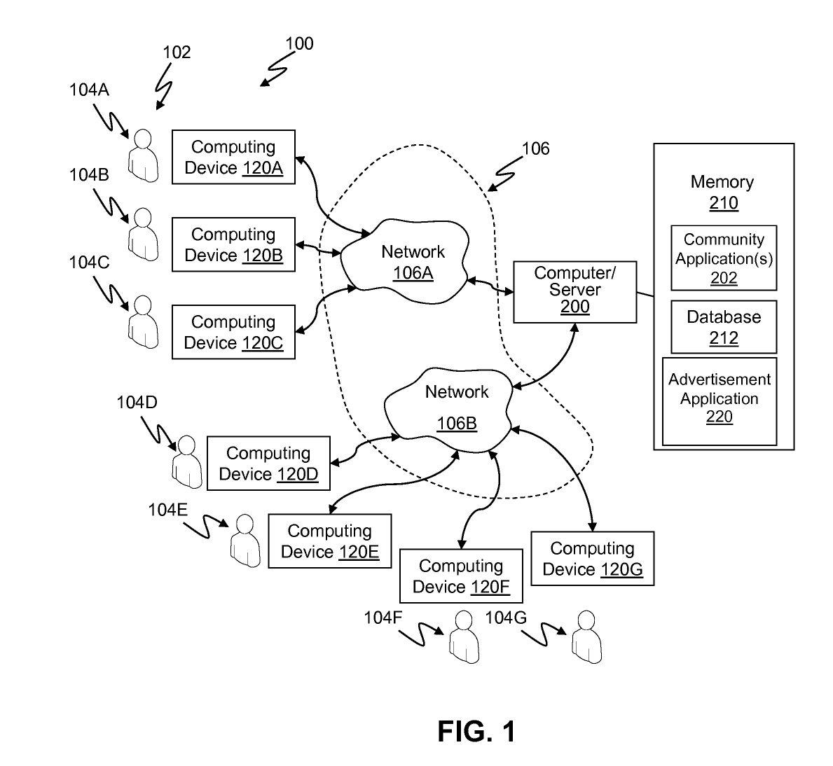

Referring to FIG. 1, an online community 100 is represented. Online community 100 is illustratively a collection of community members 102 (exemplary community members 104A-104G illustrated) which communicate through an electronic communication network 106. Electronic communication network 106 may be a collection of one or more wired or wireless networks through which a given community member 104A is able to communicate with another community member 104C.

In one embodiment, online community 100 is a closed community meaning that in order to post content or otherwise communicate with one or more of community member 102, a user must be a registered member of the online community 100. In one example, non-members of online community 100 may observe at least a portion of the content posted by online community members 102 and/or receive communications from an online community member 104. In one example, a new user must be invited to join the online community 100. In another example, a new user may freely join online community 100 by completing an account creation process, thereby becoming a registered user. An exemplary on-line community is the Job Orchard on-line community, certain features of which are described in U.S. patent application Ser. No. 12/362,926, the disclosure of which is expressly incorporated by reference herein. Exemplary account creation processes are described in U.S. patent application Ser. No. 12/322,269, the disclosure of which is expressly incorporated by reference herein.

As stated above, members 102 communicate through an electronic communication network 106. Illustratively, each member 102 may have a member account related to the online community 100. Each member 102 communicates and/or interacts as part of online community 100 through a computing device 120. Computing device 120 may be a general purpose computer or a portable computing device. Although computing device 120 is illustrated as a single computing device, it should be understood that multiple computing devices may be used together, such as over a network or other methods of transferring data. Exemplary computing devices 120 include desktop computers, laptop computers, personal data assistants (“PDA”), such as BLACKBERRY brand devices, cellular devices, tablet computers, or other devices capable of the communications discussed herein.

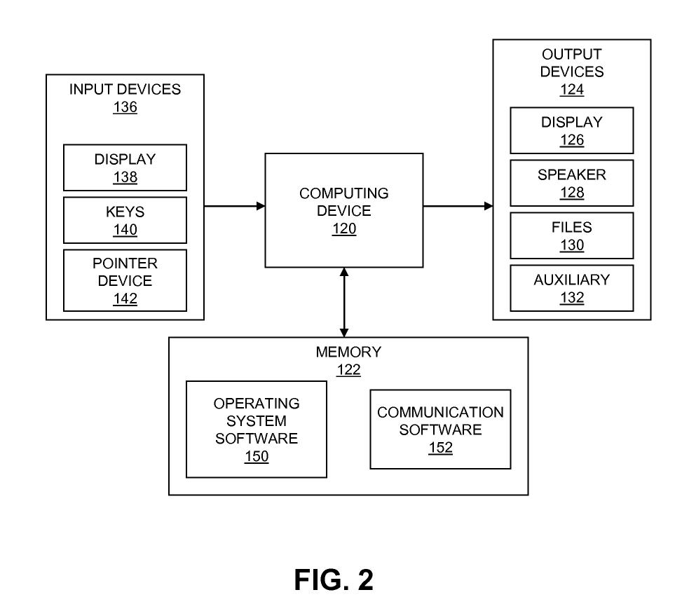

Computing device 120 has access to a memory 122 as illustrated in FIG. 2. Memory 122 is a computer readable medium and may be a single storage device or multiple storage devices, located either locally with computing device 120 or accessible across a network. Computer-readable media may be any available media that can be accessed by the computing device 120 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 120.

Computing device 120 has access to one or more output devices 124. Exemplary output devices 124 include a display 126, a speaker 128, a file 130, and an auxiliary device 132. Exemplary auxiliary devices 132 include devices which may be coupled to computing device 120, such as a printer. Files 130 may have various formats. In one embodiment, files 130 are portable document format (PDF) files. In one embodiment, files 130 are formatted for display by an Internet browser, such as Internet Explorer brand browser available from Microsoft Corporation of Redmond, Wash. or the Firefox brand browser available from Mozilla Corporation of Mountain View, Calif., and may include one or more of HyperText Markup Language (“HTML”), or other formatting instructions. In one embodiment, files 130 are files stored in memory 122 for transmission to another computing device and eventual presentation by another output device or to at least to influence information provided by the another output device.

Computing device 120 further has access to one or more input devices 136. Exemplary input devices 136 include a display 138 (such as a touch display), keys 140 (such as a keypad or keyboard), a pointer device 142 (such as a mouse, a roller ball, a stylus), and other suitable devices by which an operator may provide input to computing device 120.

Memory 122 includes an operating system software 150. An exemplary operating system software is a WINDOWS operating system available from Microsoft Corporation of Redmond, Wash. An exemplary operating system for mobile devices is the iPhone operating system available from Apple Corporation of Cupertino, Calif. Memory 122 further includes communications software 152. Exemplary communications software 152 includes e-mail software, internet browser software, and other types of software which permit computing device 120 to communicate with other computing devices across a network 106. Exemplary networks include a local area network, a cellular network, a public switched network, and other suitable networks. An exemplary public switched network is the Internet.

As discussed above and shown in FIG. 1, each of the users or members 104A-G of online community 100 are shown with an associated computing device 120A-G, respectively. Of course, a given member 104 may have multiple computing devices 120 through which the member may access a computing device 200 which provides and/or manages one or more community applications 202. As illustrated, network 106 is shown including a first network 106A and a second network 106B. For example, computing devices 120A-120C may be handheld devices which communicate with computing device 200 through a cellular network 106A while computing devices 120D-120G are computers which communicate with computing device 200 through a public switched network, such as the Internet. In one example, computing devices 120A-120C also communicate with computing device 200 through the Internet, in that the provider of cellular service provides a connection to the Internet.

Computing device 200 is labelled as Computer/Server because it serves or otherwise makes available to computing devices 120A-120G various community applications 202. In one embodiment, computing device 200 is a web server and the various community applications include web sites which are served by computing device 200. Although a single server is shown, it is understood that multiple computing devices may be implemented to function as computing device 200.

Computing device 200 has access to a memory 210. Memory 210 is a computer readable medium and may be a single storage device or multiple storage devices, located either locally with computing device 200 or accessible across a network. Computer-readable media may be any available media that can be accessed by the computing device 200 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store information and which can be accessed by the computing device 200.

In addition to one or more community applications 202, memory 210 stores one or more databases 212 which are used by the community applications 202. In one embodiment, databases 212 are stored in a MySQL database system available from MySQL AB, a subsidiary of Sun Microsystems Inc, located in Cupertino, Calif. In one embodiment, memory 210 also includes an advertisement application 220 discussed in detail below.

The types of community applications 202 depend on the type of online community. Exemplary types of online community 100 include auction sites, merchant sites, social networking sites, blogs, technical groups, professional groups, reference sites, event hosting sites, online education (e-learning) sites, online collaboration or meeting sites, news sites, and other sites wherein members are able to post content and/or exchange content. For example, at an auction site, community applications 202 include an application to list an item for auction, a posting application to provide feedback, and a message application to provide electronic messages between members. In a further example, at a social networking site, community applications may include a message application to provide electronic messages between members of the community. For news and group interest sites, community applications may include a posting application whereby a member may comment on an article presented through the news site. In yet another example, at a reference site (such as wikipedia), community applications include a content posting application to add information to the reference article and a comment posting application whereby a member may leave peer review comments about an article. In still a further example, at a career site (such as monster.com), community applications may include a job posting application and a resume submission application.

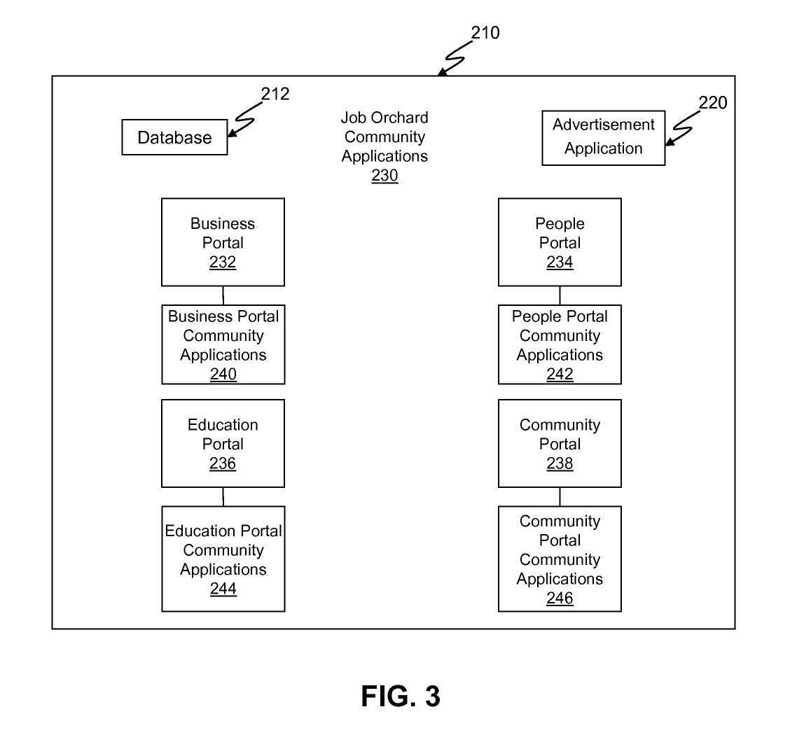

In one embodiment, online community 100 includes the community applications 230 shown in FIG. 3. Community applications 230 may be divided into four portals: business portal 232; people portal 234, education portal 236; and community portal 238. Portals 232, 234, 236, and 238 are provided by computing device 200 and are accessible by an end user over one or more networks 106 by local computing devices 120. In one embodiment, portals 232, 234, 236, and 238 are presented on display 126 of computing device 120 as a user interface. The various community applications 230 interact with a member 104 through the user interfaces and provide output information with display 126 and receive selection inputs from member 104 through input devices 136.

Business portal 232 provides information, advertisements, and/or web pages for the businesses in a real world community which are stored in databases 212. Exemplary real world communities include neighborhoods, towns, cities, townships, counties, regions, and other geographical boundaries. Another example of a business community is a cluster of businesses which consider themselves affiliated through complimentary services, operational similarities, or similar goals in the real world. Business portal 232 provides access to multiple community business applications 240. People portal 234 provides access to multiple community applications 242. Education portal 236 provides access to multiple community applications 244. Community portal 238 provides access to multiple community applications 246. Details of these portals 232, 234, 236, and 238 are provided in U.S. patent application Ser. No. 12/362,926, the disclosure of which is expressly incorporated by reference herein.

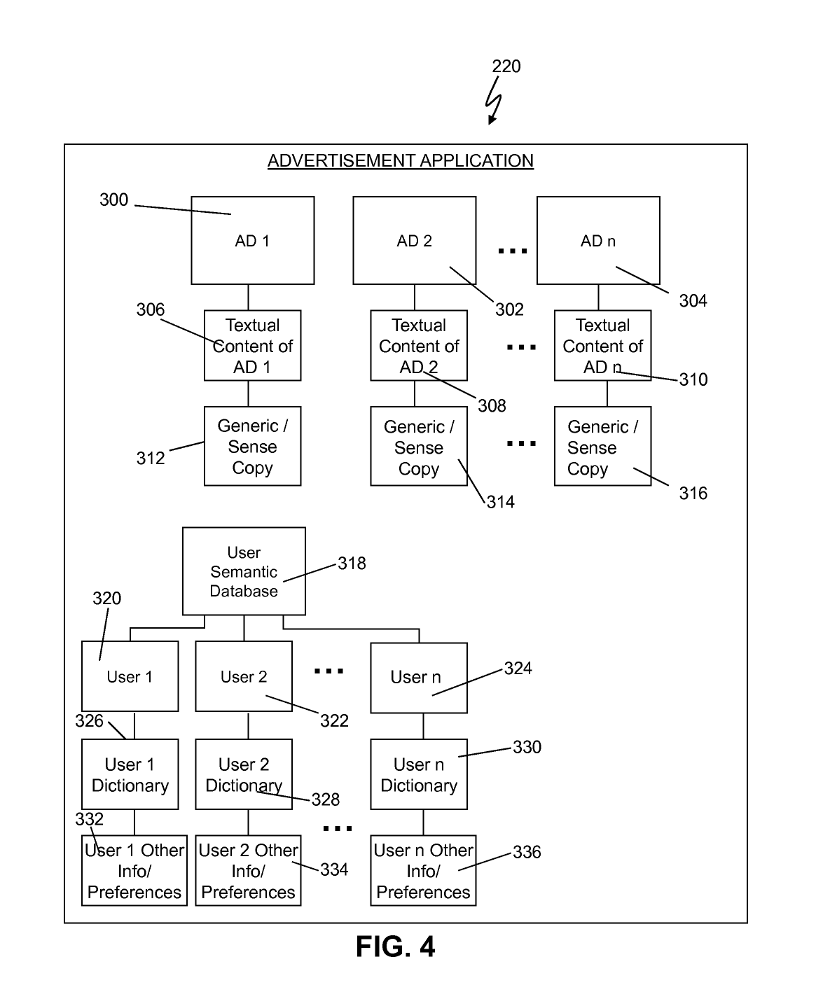

Additional details of the advertisement application 220 are illustrated in FIG. 4. The application 220 stores a plurality of advertisements 300, 302, 304 in memory 210 of computer 200. Each advertisement 300, 302, 304 may include graphical content and textual content along with other information such as color, font sizes, and styles for the particular advertisement. The textual content of the advertisements 300, 302, 304 is illustrated at blocks 306, 308, 310, respectively. The textual content is illustratively written as generic text in simple language as illustrated at blocks 312, 314, 316, respectively. The generic copy of the text is illustratively a “sense” copy of the text which provides a meaning of at least certain key words within the text. Words in the generic copy of the text may be replaced with other words to customize a dialect of the advertisement for particular users as discussed below. Although the term advertisement is used herein, language may be customized in other types of electronic communication or messages as well.

The advertisement application 220 also stores a semantic database for a plurality of users as illustrated at block 318. In an illustrated embodiment, the users are registered users or members of an online community such as Job Orchard. The database 318 includes information related to a plurality of users 320, 322, 324. As discussed in detail below, the computer 200 scans or monitors electronic communication of the plurality of users. Computer 200 performs a semantic evaluation of the text within the electronic communication to determine personal dialects used by the plurality of users. Computer 200 then builds a tailored dictionary related to each user 320, 322, 324 as illustrated at blocks 326, 328, 330, respectively.

The database 318 may also include other information or preferences for the users as illustrated at blocks 332, 334, 336. This other information and preferences may include, for example, whether the particular user is a dominant (alpha) member of a group or a subordinate (beta) member of a group as discussed in detail below. The database 318 may also include other preferences of the user such as colors, font sizes, styles, or the like. In addition, the database, may store information related to particular interests, geographic locations, or other relevant information related to the users gleaned from the electronic communications of the users.

Other information and/or preferences that may be tracked and linked to the users includes:
Political Views
Food tastes
Frequented Venues
Gaming Interests
Hobbies
Clubs/activities
Personal strengths and weaknesses for providing explanations in tutorials at the correct level of detail (Math, English, Finance). A person who has bad grammar and limited vocabulary might get a more basic English tutorial, and someone who has discussed having problems understanding a home loan might be pointed toward a basic financial tutorial.
Collectables they are interested in (baseball cards, stamps, etc.)

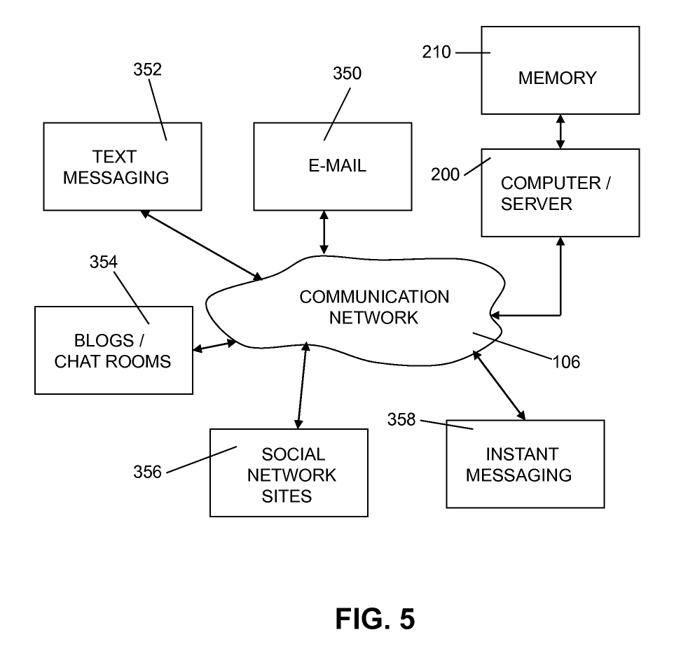

As discussed above in connection with FIG. 1, individual members or users 104 use various forms of electronic communication over the communication network 106. As illustrated in FIG. 5, users 104 may generate electronic communications in the form of e-mails 350, text messaging 352, blogs or chat rooms 354, social network sites 356, and instant messaging 358, for example. All of such messaging services may be hosted by a single online community or may be multiple services or online communities linked together. For instance, Job Orchard or other online community may link with other social network sites such as Facebook, Myspace, LinkedIn, Twitter, or with e-mail service providers. In other words, the computer 200 may use the advertisement application 220 information to share targeted advertising language information with external sites such as the social network sites 356 or with external e-mail sites such as Gmail provided by Google. Computer 200 monitors the electronic communication from the different sources illustrated in FIG. 5, or other electronic communication, to build the database 318 as discussed in more detail below.

The user dialect profile (including interests) may be stored on a server 200 accessible by other approved websites and services. The system of the present invention may provide a common framework and repository for holding a user's dialect and interests. This is similar to the way the credit bureaus provide a person's credit score to third parties, or the way OpenIDs allow a shared login across many websites (the dialect profile may even be tied to an OpenID). From a technical side, the dialect profile is transmitted securely from the main server 200 to a requesting site with the proper credentials in a shared format, for example XML.

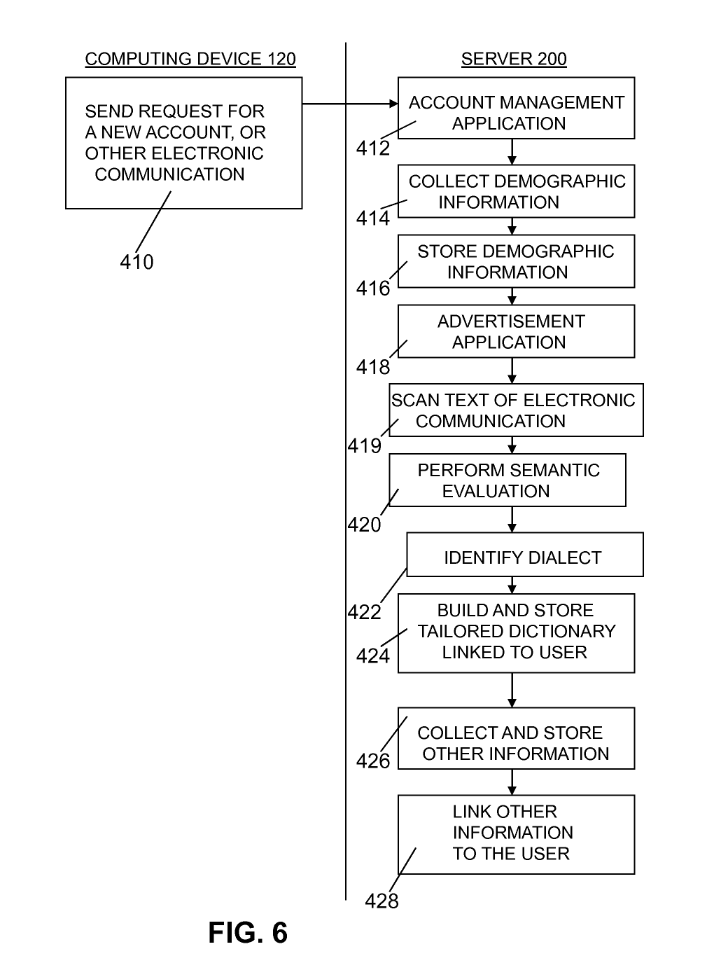

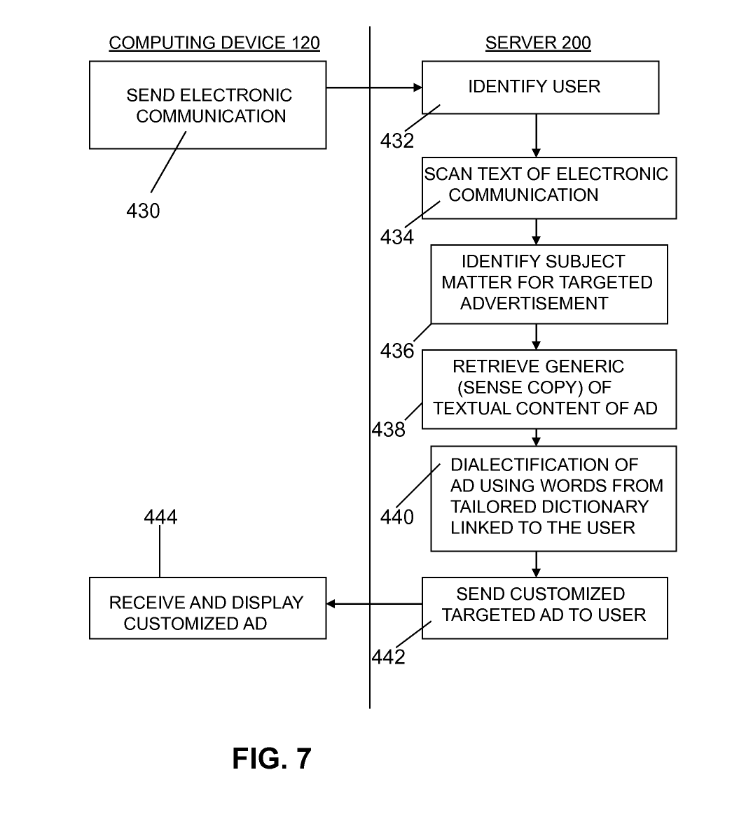

Additional details of the method and apparatus for generating advertisements or other electronic messages are illustrated in FIGS. 6 and 7. As shown in FIG. 6, a user may use one of the computing devices 120 to send a request for a new account or to send an electronic communication as illustrated at block 410. The server computer 200 uses an account management application to process requests for new accounts. An illustrative account management application is disclosed in U.S. application Ser. No. 12/322,269, which is incorporated herein by reference. Other suitable account management applications may also be used.

The account management application collects demographic and/or psychographic information as illustrated at block 414. For instance, the user may provide personal information such as name, address, e-mail, age, income level or other information relating to personality, values, attitudes, interests, or lifestyles at block 414. The demographic and/or psychographic information is stored in memory 210 of computer 200 and linked to a particular user as illustrated at block 416.

Computer 200 may also run the advertisement application 220 as illustrated at block 418. The advertisement application 220 automatically scans or monitors text of electronic communication provided by the user as illustrated at block 419. Computer 200 performs a semantic evaluation on the text as illustrated at block 420 and identifies a dialect used by the user as in the electronic communication as illustrated at block 422. The information gleaned from the electronic communication is stored in a tailored dictionary and reference set linked to the particular user as illustrated at block 424 and discussed above in connection with FIG. 4.

Computer 200 may also collect and store other information from the electronic communication as illustrated at block 426. Such other information may include color preferences, font or style preferences or other information related to areas of interest, geographical preferences, or other desired information related to the user. The other information collected at block 426 is linked to the particular user as illustrated at block 428.

In an illustrated embodiment, a listing of a plurality of often used words is provided in the dictionary along with word's generic meaning or “sense”. For each of the generic words, the computer 200 detects words with the same meaning used by a particular user in the electronic communication. A particular dialect of the user is therefore linked to the generic words to build the semantic database 318.

The system has a list of key concepts and references that it will target first. These are illustratively references that are of the most value initially, such as product preferences which are used to improve targeted advertising. Beyond the list of key concepts and references, there is also other useful information. For this information, the system scans the whole text base of a user, noting words of interest and applying a confidence level which determines if a particular word can be applied to a useful task and for that particular user. Confidence in usefulness comes from a variety of factors like frequency of use, positive/negative context, word part, word sense, etc.

In another embodiment, the advertisement application 220 may provide a plurality of different dictionaries related to different groups based upon demographic and/or psychographic information. For instance, dictionaries may be based on age, occupation, area of the country, or other desired user information. The users are then classified into a particular demographic and/or psychographic group and the dialect for that particular group is used when communicating with users classified in the group. In other words, instead of building a tailored dictionary for each individual user, tailored dictionaries for sub-categories of users based upon demographic and/or psychographic information may be established and then the users are linked to the particular groups. It is understood that the group profiles and individual profiles may be used separately or together as desired. A user dialect profile for a particular individual may include a combination of words and references from both their individual profile and profiles of group(s) to which the individual belongs.

Once the semantic database 318 is established as discussed above, the database 318 is used to provide targeted, customized advertisements or other communication to particular users as illustrated, for example, in FIG. 7. A particular user sends an electronic communication via the communication network 106 using a computing device 120 as illustrated at block 430. Computer 200 first identifies the user. If the communication is within a closed online community, the computer 200 may use the user's member registration or login information to identify the user. In open communities, cookies or other identification information may be used to identify the user as illustrated at block 432. Other ways that a user may be identified include, in any combination, an IP address, geotagging, geotargeting, mobile device ID, phone number, similar usernames, open ID, biometrics, linguistic profile, word frequency, who they are talking to, what they are talking about, etc.

Next, computer 200 scans or monitors the text of the electronic communication as illustrated at block 434. The subject matter for a targeted advertisement is then identified at block 436. Such subject matter may be identified using conventional methods of identifying key terms used in the electronic communication and linking those key terms to targeted advertisements. For example, computer 200 identifies one of the plurality of advertisements 300, 302, 304 discussed above as being related to the electronic communication.

Next, computer 200 retrieves the generic or sense copy of the textual content of the advertisement as illustrated at block 438. Computer 200 then accesses the semantic database 318 to determine the particular user dialect profile for the identified user and performs a dialectification of the generic version of the textual content of the ad as illustrated at block 440. In other words, the specific words, reference, and styles from the tailored dictionary 326, 328, 330 related to the identified user 320, 322, 324 are selected to replace words, phrases, or concepts in the generic textual content of the advertisement. It is understood that the dialectification of ad using words from tailored dictionary at block 440 may include the use of words, memes, syntax, and references. In other words, block 440 may provide more than just word replacement, it may tailor syntax, make references to opinions they hold, etc. Computer 200 then sends the customized, targeted advertisement to the user as illustrated at block 442. The user's computing device 120 receives and displays the customized targeted advertisement as illustrated at block 444.

In an illustrated example, a generic or “sense” copy of textual content of an advertisement for a cell phone may be: “Samsung L34 battery lasts a very long time”. For a 50 year old business man the advertisement application 220 may generate a targeted, customized ad which states: “The Samsung L34 lasts longer than a Friday afternoon business meeting.” The reference to long Friday business meetings was something extracted from the man's own blog and is written in proper English as he writes. In contrast, for a teenage user the targeted, customized ad may state: “Samsung L34—OMG the battery lasts 4ever.” This text is much more informal and includes slang that the teenager has used in other electronic communication. The same generic ad copy can therefore target and be customized for many different audiences.

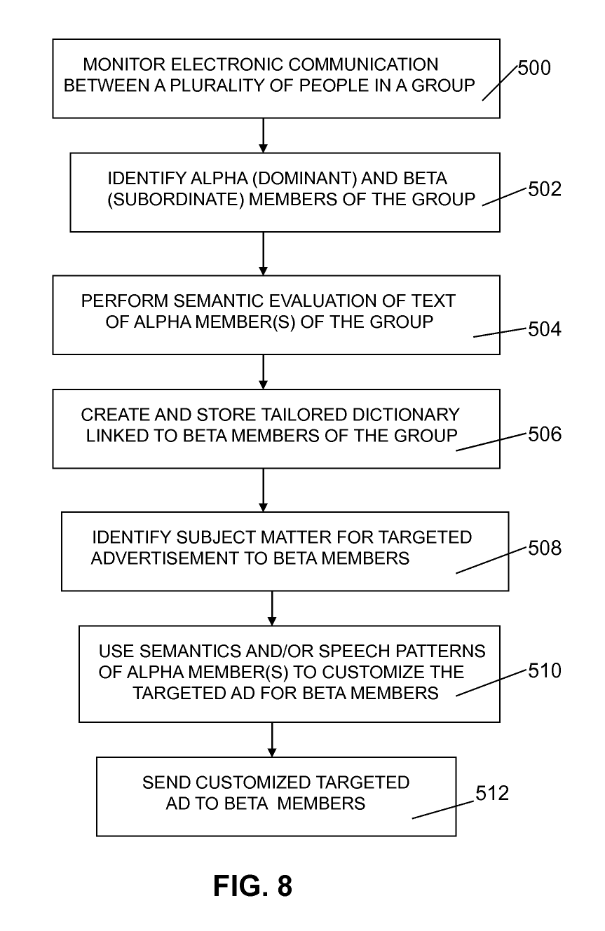

As illustrated in FIG. 8, in another illustrated embodiment, the computer 200 monitors electronic communication from a plurality of users within a group of users using different computing devices 120 as illustrated at block 500. For example, the users may be members of an online community, friends on a social networking site, members of a chat room or blog, or other group which often communicates via electronic communication. The computer 200 may build tailored dictionaries as discussed above for each of the individual users within the group.

In another embodiment of the present invention, the tailored language content provided to an individual may be stylized to reflect the language of one or more persons which communicate with the individual and for whom the individual appears to trust, follow and/or respect. The language content of communication to the individual user, such as advertisements, may be tailored based on language used by peers of the individual. Computer 200 also identifies alpha or dominant members of the group and beta or subordinate members of the group as illustrated at block 502. In an illustrated embodiment, the semantics or speech patterns of alpha members of the group are used when communicating with the beta members of the group. The beta members of the group may be more receptive to advertisements written in “alpha speak” than they would to ads written in their own dialect. Illustratively, an attempt to determine an individual is more responsive to alpha speak than their own dialect is made in order to decide whether to continue using alpha speak with that individual. Therefore, computer 200 performs a semantic evaluation of text of the alpha members of the group as illustrated at block 504. Computer 200 then creates and stores a tailored dictionary linked to beta members of the group as illustrated at block 506. In particular, the semantics or dialects used by the alpha members are linked to beta members of the group at block 506.

It is understood that a person may be an alpha member or beta member within a group and/or within a context within that group. For example: Sam and Bob may be members of the same group, but with regard to clothing Sam is an alpha member while Bob is beta member. With regard to music, Bob is an alpha member and Sam is beta member. So in some cases people may simply be alpha members, but other cases it make be context dependent. A person may belong to multiple groups. Therefore, Bob may be alpha member in his model car club, but a beta member amongst his model rocket club, for example.

In an illustrated example, an analysis of time progression of memes used within writing and other on-line behavior may be used to distinguish between alpha members of the group and beta members of the group at block 502. A meme is a unit or element of a cultural idea, symbol or practice. Alpha members of the group will generally use a meme first, and beta members will later adopt the meme and follow it. Any subject or action that can be tracked in time, such as memes, websites visited, or other information may be used to help establish and identify alpha members and beta members within the group. This tracking may be accomplished by frequent scanning of the text in electronic communications which is time-stamped or otherwise dated to track which members of the group started the action and which members of the group followed others' suggestions.

Methods of identifying alpha and beta members of the groups may include:
Command phrases directed at other users
Instructional tone/words directed at other users

Additionally, the system may use data from offline meetings to determine the alpha members and beta members of a group using known techniques. The system may scan writing samples from each participant for distinguishing characteristics that correlate with alphas and betas. Thus, the system can find new, previously unknown textual markers for dominance. This scan for correlation can be directed toward hypothesized correlates between the online and offline world, like CAPITAL letters mean yelling and indicate dominance, for example. The algorithm may also look for correlations entirely on its own, without human proposed hypothesis. With sufficient data this should yield some interesting and useful markers of dominance.

After the tailored dictionary is built at block 506, computer 200 scans electronic communication to identify the subject matter for targeted advertisements to beta members of the group as illustrated at block 508. For example, the advertisement application 200 may select a particular ad 300, 302, 304 for a targeted advertisement based on the scan of electronic communication from a beta member of the group. Computer 200 then replaces generic textual information of the ad with semantics or speech patterns of an alpha member to customize the targeted ad for beta members as illustrated at block 510. The customized targeted advertisement is then sent to the beta member as illustrated at block 512.

In another illustrated embodiment, the information discussed above related to the semantic evaluation and dialogue extraction may be used in settings other than electronic communications. For instance, a sales representative or other person may access information stored in the user's semantic database 318 before they speak to or otherwise communicate with the user. Review of the tailored dictionary or other preferences of a particular user may permit the representative to communicate better with the user face-to-face. Such information may also be useful to technical support personnel or others who must communicate with users. By generating a dialect summary or semantic profile of a user as discussed above, a customer service representative or technical support person may review the semantic profile and match users with appropriate representatives or tech support personnel. This will assist in phone communication, e-mail tech support or other electronic communication with the user. In other words the particular user can be routed to a person who speaks or otherwise uses dialects or language similar to the particular user.

Although the invention has been described in detail with reference to certain illustrated embodiments, variations and modifications exist within the spirit and scope of the invention as described and defined in the following claims.

What is claimed is:

1. A method for automatically generating and delivering customized targeted advertisements from a first computing device to a second computing device used by a user, the method comprising:
receiving an electronic communication at the first computing device from the second computing device used by a user;
identifying the user with the first computing device;
scanning textual content of the electronic communication from the user with the first computing device to determine a subject matter for a targeted advertisement;
retrieving a generic version of textual content of the targeted advertisement with the first computing device;
accessing a semantic database including a dialect profile linked to the identified with the first computing device to determine a dialect profile for the identified user;
performing a dialectification of the generic version of textual content of the targeted advertisement with the first computing device to create a customized targeted advertisement for the identified user; and
sending the customized targeted advertisement from the first computing device to the second computing device for display to the identified user.

2. The method of claim 1, wherein specific words, references, and styles from a tailored dictionary related to the identified user are selected from the semantic database to replace at least one of words, phrases, and concepts in the generic version of textual content of the targeted advertisement.

3. The method of claim 1, wherein the dialectification of the generic version of the textual content of the targeted advertisement tailors syntax of the targeted advertisement.

4. The method of claim 1, wherein the dialectification of the generic version of the textual content of the targeted advertisement makes references to opinions held by the user.

5. The method of claim 1, wherein the first computing device uses at least one of a member registration and login information of the user in the identifying step.

6. The method of claim 1, wherein the first computing device uses a cookie received from the second computing device in the identifying step.

7. The method of claim 1, wherein the first computing device uses one of an IP address, geotagging, geotargeting, a mobile device ID, a phone number, a user name, an open ID and biometric data in the identifying step.

8. The method of claim 1, wherein the step of scanning textual content of the electronic communication from the user with the first computing device to determine subject matter for a targeted advertisement includes identifying key terms used in the electronic communication and finding targeted advertisements linked to the identified key terms.
